(19) United States
(12) Patent Application Publication
(10) Pub. No.: US 2023/0176864 A1
(43) Pub. Date: Jun. 8, 2023

(54) PARALLEL PROCESSING APPARATUS AND COMPUTER-READABLE RECORDING MEDIUM STORING PARALLEL PROCESSING PROGRAM

(71) Applicant: FUJITSU LIMITED, Kawasaki-shi (JP)

(72) Inventor: Masafumi YAMAZAKI, Tachikawa (JP)

(73) Assignee: FUJITSU LIMITED, Kawasaki-shi (JP)

(21) Appl. No.: 17/932,866

(22) Filed: Sep. 16, 2022

(30) Foreign Application Priority Data
Dec. 3, 2021 (JP) 2021-196959

(51) Int. Cl. G06F 9/30; G06F 7/57; G06F 15/80

(52) U.S. Cl. CPC G06F 9/3001; G06F 7/57; G06F 15/80

(57) ABSTRACT

A parallel processing apparatus comprises a plurality of arithmetic processors and a plurality of storages. A first processor executes first processing included in parallel processing by using first unit of processing, a second processor executes second processing by using second unit of processing, a first storage stores first information and a second storage stores second information, each to be used by the first and the second processors in an aggregate operation, the first information contains first parent information indicating that the second unit of processing is a parent of the first unit of processing, the second information contains first child information indicating that the first unit of processing is a child of the second unit of processing, and the first processor transmits an end notification to the second processor when the first processing is ended and the first information does not contain information indicating a child of the first unit.

### CROSS-REFERENCE TO RELATED APPLICATION

This application is based upon and claims the benefit of priority of the prior Japanese Patent Application No. 2021-196959, filed on Dec. 3, 2021, the entire contents of which are incorporated herein by reference.

### FIELD

Embodiments discussed herein are related to a parallel processing technique.

### BACKGROUND

Regarding parallel processing, there is known a method for optimizing resource usage in a distributed computing environment. An algorithm is also known in which multiple nodes that perform an aggregate operation in parallel processing perform communication based on a binary tree.

U.S. Pat. Application Publication No. 2018/0365072 is disclosed as related art.

“Massively Scale Your Deep Learning Training with NCCL 2.4 | NVIDIA Developer Blog”, NVIDIA, Nov. 8, 2021, [online], [searched on Oct. 5, 2021], Internet <URL:https://developer.nvidia.com/blog/massively-scale-deep-learning-training-nccl-2-4/> and P. Sanders et al., “Two-tree Algorithms for Full Bandwidth Broadcast, Reduction and Scan”, Parallel Computing, Volume 35, Issue 12, pages 581-594, December, 2009 are also disclosed as related art.

### SUMMARY

According to an aspect of the embodiments, a parallel processing apparatus including a plurality of arithmetic processors and a plurality of storages, wherein a first arithmetic processor among the plurality of arithmetic processors executes processing for executing first processing included in parallel processing by using a first unit of processing among a plurality of units of processing, a second arithmetic processor among the plurality of arithmetic processors executes processing for executing second processing included in the parallel processing by using a second unit of processing among the plurality of units of processing, a first storage among the plurality of storages stores first information to be used by the first arithmetic processor in an aggregate operation in the parallel processing, a second storage among the plurality of storages stores second information to be used by the second arithmetic processor in the aggregate operation, the first information contains first parent information which indicates that the second unit of processing is a parent of the first unit of processing, the second information contains first child information which indicates that the first unit of process is a child of the second unit of processing, the first arithmetic processor further executes processing for transmitting an end notification to the second arithmetic processor in a case where the first processing is ended and the first information does not contain information which indicates a child of the first unit of processing, and the second arithmetic processor further executes processing for deleting the first child information from the second information in a case where the second arithmetic processor receives the end notification from the first arithmetic processor

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are diagrams illustrating sample data and causal relationships;

FIG. 2 is a diagram illustrating parallelized causal discovery processing;

FIG. 3 is a diagram illustrating a communication tree of Allreduce;

FIG. 4 is a diagram illustrating communication tree information;

FIG. 5 is a diagram illustrating Allreduce;

FIG. 6 is a functional configuration diagram of a parallel processing apparatus;

FIG. 7 is a flowchart of parallel processing;

FIG. 8 is a hardware configuration diagram of the parallel processing apparatus;

FIG. 9 is a hardware configuration diagram of an information processor to be used as a management device;

FIG. 10 is a hardware configuration diagram of an information processor to be used as a node device;

FIG. 11 is a diagram illustrating an end order in a case where causal discovery processing is executed;

FIG. 12 is a diagram illustrating a communication tree to be used in an aggregate operation;

FIG. 13 is a diagram illustrating communication tree information stored in node devices;

FIG. 14 is a diagram illustrating the communication tree information after a first change;

FIG. 15 is a diagram illustrating the communication tree information after a second change;

FIG. 16 is a diagram illustrating the communication tree after the first change;

FIG. 17 is a diagram illustrating the communication tree information after a third change;

FIG. 18 is a diagram illustrating the communication tree information after a fourth change;

FIG. 19 is a diagram illustrating the communication tree after the second change;

FIG. 20A is a flowchart (part 1) of an aggregate operation;

FIG. 20B is the flowchart (part 2) of the aggregate operation;

FIGS. 21A and 21B are diagrams illustrating processing times in cases where two types of causal discovery processing jobs are executed; and

FIGS. 22A and 22B are diagrams illustrating processing times in cases where three types of jobs are executed.

### DESCRIPTION OF EMBODIMENTS

In parallel processing by multiple processes, there is a case where the number of processes that participate in an aggregate operation gradually decreases and unnecessary processes that do not participate in the aggregate operation continuously occupy computational resources. In this case, it is desirable to end the unnecessary processes in the middle of the processing and release the computational resources occupied by the processes as early as possible.

Such a problem occurs not only in parallel processing using processes but also in parallel processing using various units of processing. Here, the term “unit” means a chunk of processes, and does not mean any hardware device

According to one aspect, an object of the present disclosure is to release computational resources in units of processing in the order in which processing is ended in parallel processing including an aggregate operation.

Hereinafter, embodiments are described in detail with reference to the drawings.

A direct linear non-Gaussian acyclic model (DirectLiNGAM) is known as an example of a causal discovery method for discovering causal relationships between variables from observed sample data. In DirectLiNGAM, directed causal relationships between variables are derived instead of correlations between variables.

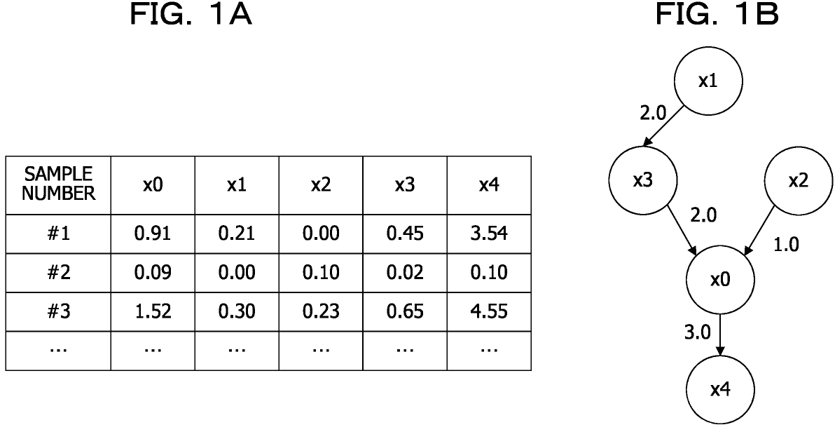

FIGS. 1A and 1B illustrate examples of sample data and causal relationships. FIG. 1A illustrates an example of observed sample data. A sample number is identification information of sample data, and x0 to x4 represent variables. For example, in the sample number #1, sample data for x0 is 0.91, sample data for x1 is 0.21, sample data for x2 is 0.00, sample data for x3 is 0.45, and sample data for x4 is 3.54.

FIG. 1B illustrates an example of causal relationships derived from the sample data in FIG. 1A. The causal relationships in FIG. 1B may be represented by the following formulae.

$$\text{x3} = 2 \times \text{x1}$$

$$\text{x0} = 1 \times \text{x2} + 2 \times \text{x3}$$

$$\text{x4} = \text{3} \times \text{x0}$$

For example, an information processor that performs causal discovery processing in DirectLiNGAM obtains an order of variables in causal relationships from sample data for K variables (K is an integer of two or more) in accordance with the following procedure.

(P1) The information processor performs bi-directional regression analysis on all combinations of two of the K variables as processing targets, and calculates a residual entropy difference diff thereof.

(P2) The information processor obtains the sum of squares of the differences diff as a correlation degree for each variable, and identifies, as a leading (most significant) variable, the variable having the minimum correlation degree among the variables of the processing targets.

(P3) The information processor regresses each of the other variables on the leading variable and sets the residuals as new sample data. Accordingly, the contribution of the leading variable is removed.

(P4) The information processor removes the sample data for the leading variable. As a result, the number of the remaining other variables is smaller just by one than the number of the variables of the processing targets.

The information processor repeats the processing (P1) to (P4) for the other variables as the processing targets. As a result of k-1 times of executions of the processing of (P1) to (P4), the order of the K variables is determined.

Because the processing (P1) is executable independently for each variable, the causal discovery processing in DirectLiNGAM may be parallelized by s processes (s is an integer of two or more). In a case of parallelization of the causal discovery processing, a rank number r (r = 0, 1, 2, ..., s-1) is assigned to each process. The rank number r is identification information of a process.

Hereinafter, a process with a rank number r may be referred to as p(r). Each process p(r) performs the causal discovery processing in the following procedure.

(P11) The processes p(0) to p(s-1) take charge of N variables of processing targets dividedly. The variables are allocated to the processes in ascending order of the rank number such that the number of variables assigned to the process p(r) is equal to or greater than the number of variables assigned to the process p(r+1).

For example, in a case where variables of processing targets are x0, x1, x2, x3, and x4 and four processes perform causal discovery processing, N = 5 and s = 4. In this case, the variables to be assigned to the processes p(r) (r = 0, 1, 2, 3) are determined as follows.
p(0): x0, x1
p(1): x2
p(2): x3
p(3): x4

Each process p(r) performs bi-directional regression analysis on all combinations of each assigned variable and each of the other variables, and calculates a residual entropy difference diff thereof.

Accordingly, the process p(0) calculates the residual entropy difference diff based on x0 with respect to each of x1, x2, x3, and x4 and calculates the residual entropy difference diff based on x1 with respect to each of x0, x2, x3, and x4.

The process p(1) calculates the residual entropy difference diff based on x2 with respect to each of x0, x1, x3, and x4. The process p(2) calculates the residual entropy difference diff based on x3 with respect to each of x0, x1, x2, and x4. The process p(3) calculates the residual entropy difference diff based on x4 with respect to each of x0, x1, x2, and x3.

(P12) Each process p(r) obtains, as a correlation degree, the sum of squares of the calculated differences diff for each assigned variable.

Accordingly, the process p(0) calculates the correlation degree for each of x0 and x1, the process p(1) calculates the correlation degree for x2, the process p(2) calculates the correlation degree for x3, and the process p(3) calculates the correlation degree for x4.

Each process p(r) shares the correlation degree for each of the N variables with the other processes through inter-process communication in an aggregate operation of a message passing interface (MPI). Each process p(r) identifies, as the leading variable, the variable having the minimum correlation degree among the N variables. In this way, the s processes share the information on the leading variable.

(P13) Each process p(r) regresses each of the other variables on the leading variable and sets the residuals as new sample data.

(P14) Each process p(r) removes the sample data for the leading variable. As a result, the number of the variables of the processing targets becomes N-1, and the parallelism of the causal discovery processing decreases.

For example, in a case where x1 is identified as the leading variable among x0 to x4, the next processing targets are x0, x2, x3, and x4, and the parallelism decreases from 5 to 4.

The processes p(0) to p(s-1) repeat the processing (P11) to (P14) for the remaining N-1 variables as the processing targets. In the processing (P11) at this time, the variables are reassigned to the processes p(r) such that the larger the rank number of a process, the smaller the number of variables assigned to the process.

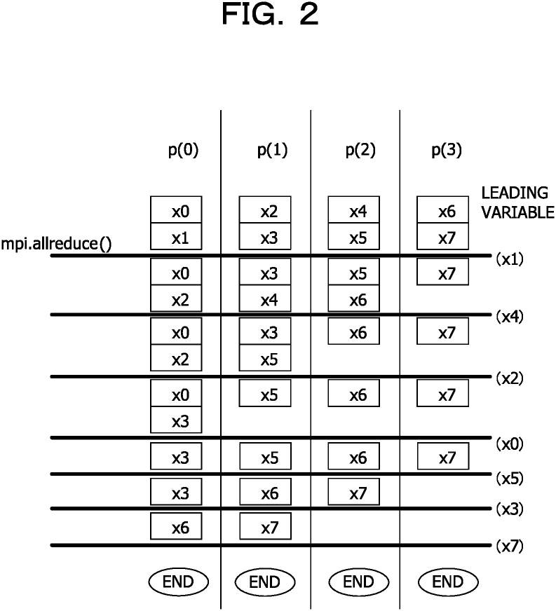

FIG. 2 illustrates an example of parallelized causal discovery processing. Processing targets are eight variables x0 to x7, and four processes p(0) to p(3) perform the causal discovery processing. Accordingly, K = 8 and s = 4.

Each rectangle represents processing of calculating the correlation degree for a variable. A variable name in each rectangle represents a variable assigned to the corresponding process p(r). Each horizontal line represents an aggregate operation Allreduce executed based on an aggregate operation instruction mpi.allreduce(). A variable name written on the right side of each horizontal line represents the leading variable identified based on the correlation degrees shared through Allreduce.

In an initial state, N = K = 8 and the variables are allocated to the processes p(r) (r = 0, 1, 2, 3) as follows.
p(0): x0, x1
p(1): x2, x3
p(2): x4, x5
p(3): x6, x7

In the first Allreduce, x1 is determined as the leading variable, and the next processing targets are x0 and x2 to x7. Accordingly, N = 7, and the variables are allocated to the processes p(r) as follows.
p(0): x0, x2
p(1): x3, x4
p(2): x5, x6
p(3): x7

In the second Allreduce, x4 is determined as the leading variable, and the next processing targets are x0, x2, x3, and x5 to x7. Accordingly, N = 6, and the variables are allocated to the processes p(r) as follows.
p(0): x0, x2
p(1): x3, x5
p(2): x6
p(3): x7

In the third Allreduce, x2 is determined as the leading variable, and the next processing targets are x0, x3, and x5 to x7. Accordingly, N = 5, and the variables are allocated to the processes p(r) as follows.
p(0): x0, x3
p(1): x5
p(2): x6
p(3): x7

In the fourth Allreduce, x0 is determined as the leading variable, and the next processing targets are x3 and x5 to x7. Accordingly, N = 4, and the variables are allocated to the processes p(r) as follows.
p(0): x3
p(1): x5
p(2): x6
p(3): x7

At the fifth Allreduce, x5 is determined as the leading variable, and the next processing targets are x3, x6, and x7. Accordingly, N = 3, and the variables are allocated to the processes p(r) as follows.
p(0): x3
p(1): x6
p(2): x7
p(3): None

In the sixth Allreduce, x3 is determined as the leading variable, and the next processing targets are x6 and x7. Accordingly, N = 2, and the variables are allocated to the processes p(r) as follows.
p(0): x6
p(1): x7
p(2): None
p(3): None

In the seventh Allreduce, x7 is determined as the leading variable, and only x6 remains. As a result, the order of the variables is determined to be x1, x4, x2, x0, x5, x3, x7, and x6.

As described above, as the causal discovery processing proceeds, the number of the rectangles gradually decreases, and a process p(r) not taking charge of any variable is generated when the number of the rectangles becomes smaller than s. However, since mpi.allreduce() is issued to all the processes p(r) even after the process p(r) not taking charge of any variable is generated, the processing by the processes p(r) is not ended until the order of the K variables is determined.

Allreduce is processing in which all of multiple processes participating in parallel processing share statistical values of data held by the respective processes, a statistical value calculated by obtaining the rank number or the like of a process holding specific data, and the rank number or the like. The statistical value is, for example, a total sum, a maximum value, or a minimum value, and the specific data is, for example, the maximum value or the minimum value. As the inter-process communication for Allreduce, for example, communication based on a binary tree described in NVIDIA and P. Sanders et al. may be used.

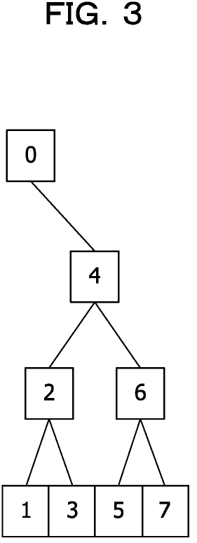

FIG. 3 illustrates an example of a communication tree of Allreduce. The communication tree in FIG. 3 is a binary tree. Each rectangle represents a node serving as a process p(r), and a number in the rectangle represents a rank number r. In this example, Allreduce is performed by eight processes p(r) (r = 0 to 7).

The node p(0) has no parent node, and the child node of the node p(0) is the node p(4). The parent node of the node p(4) is the node p(0), and the child nodes of the node p(4) are the nodes p(2) and p(6).

The parent node of the node p(2) is the node p(4), and the child nodes of the node p(2) are the nodes p(1) and p(3). The parent node of the node p(6) is the node p(4), and the child nodes of the node p(6) are the nodes p(5) and p(7).

The parent node of the nodes p(1) and p(3) is the node p(2), and the parent node of the nodes p(5) and p(7) is the node p(6). The nodes p(1), p(3), p(5), and p(7) have no child nodes.

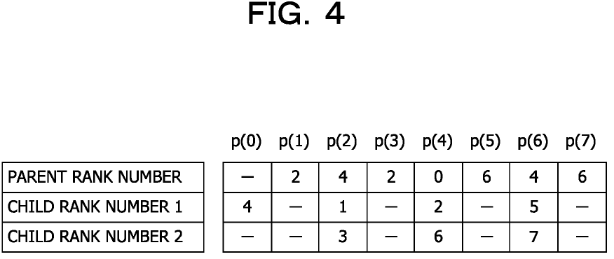

FIG. 4 illustrates an example of communication tree information held by each process p(r) in FIG. 3. The communication tree information in FIG. 4 contains a parent rank number, a child rank number 1, and a child rank number 2. The parent rank number indicates a rank number of a process serving as the parent node of a process p(r), and a child rank number 1 and a child rank number 2 indicate rank numbers of processes serving as the child nodes of the process p(r). Here, “-” indicates that the process p(r) has no corresponding parent node or child node.

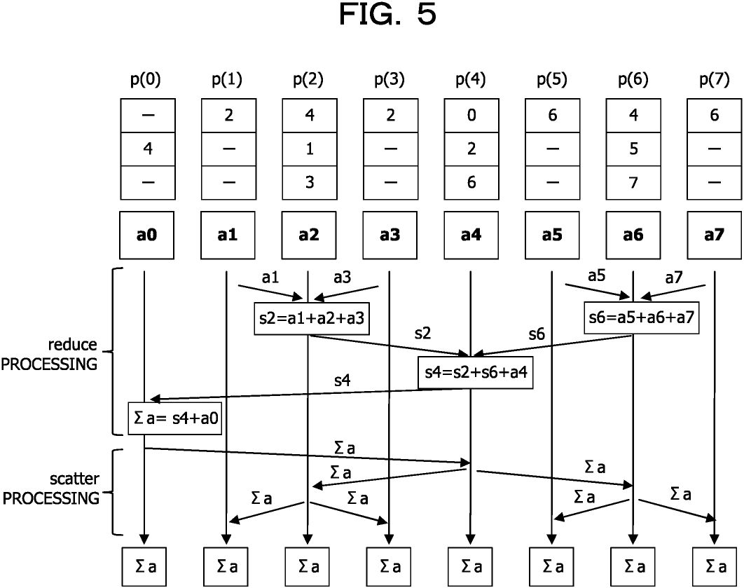

FIG. 5 illustrates an example of Allreduce executed by the processes p(0) to p(7) in FIG. 3. In this example, each process p(r) holds data ar, and the total sum Σa of a0 to a7 is shared among the processes p(0) to p(7). Allreduce includes reduce processing and scatter processing.

In the reduce processing, the process p(r) having only the parent rank number transmits the data ar to the process indicated by the parent rank number. Accordingly, p(1) transmits a1 to p(2), and p(3) transmits a3 to p(2). Furthermore, p(5) transmits a5 to p(6), and p(7) transmits a7 to p(6).

Next, the process p(r) having the parent rank number and the child rank numbers receives the data from the processes indicated by the child rank numbers, calculates the total sum of the received data and the data ar, and transmits the calculated total sum to the process indicated by the parent rank number. Accordingly, p(2) calculates the total sum s2 of a1 to a3 and transmits the total sum s2 to p(4), and p(6) calculates the total sum s6 of a5 to a7 and transmits the total sum s6 to p(4). Furthermore, p(4) calculates the total sum s4 of s2, s6, and a4 and transmits the total sum s4 to p(0).

Subsequently, the process p(r) having only the child rank number receives the data from the process indicated by the child rank number, and calculates the total sum of the received data and the data ar. Accordingly, p(0) calculates the total sum Σa of s4 and a0.

In the scatter processing, the process p(r) having only the child rank number transmits the calculated total sum to the process indicated by the child rank number. Accordingly, p(0) transmits Σa to p(4).

Next, the process p(r) having the parent rank number and the child rank numbers receives the total sum from the process indicated by the parent rank number, and transmits the received total sum to the processes indicated by the child rank numbers. Accordingly, p(4) receives Σa from p(0) and transmits the received Σa to p(2) and p(6). Then, p(2) receives Σa from p(4) and transmits the received Σa to p(1) and p(3). Meanwhile, p(6) receives Σa from p(4) and transmits the received Σa to p(5) and p(7).

Next, the process p(r) having only the parent rank number receives the total sum Σa from the process indicated by the parent rank number. Accordingly, p(1) and p(3) receive Σa from p(2), whereas p(5) and p(7) receive Σa from p(6).

In the case of the causal discovery processing in FIG. 2, information on the variable having the minimum correlation degree among the N variables is shared among the processes p(0) to p(3) through Allreduce. However, as the causal discovery processing proceeds, a process p(r) not taking charge of any variable is generated. In this case, since the result of the causal discovery processing does not change even though the process p(r) not taking charge of any variable is deleted, it is possible to end the process p(r) in the middle.

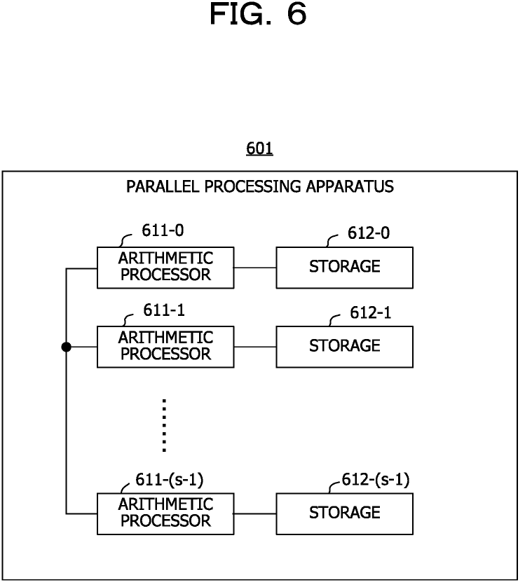

FIG. 6 illustrates a functional configuration example of a parallel processing apparatus according to the embodiment. A parallel processing apparatus 601 illustrated in FIG. 6 includes arithmetic processors 611-0 to 611-(s-1) (s is an integer of two or more) and storages 612-0 to 612-(s-1).

Any arithmetic processor 611-m (m = 0 to s-1) serves as a first arithmetic processor and any arithmetic processor 611-q (q = 0 to s-1, q ≠ m) serves as a second arithmetic processor. The storage 612-m serves as a first storage, and the storage 612-q serves as a second storage.

The arithmetic processor 611-m executes first processing included in parallel processing by using a first unit of processing among multiple units of processing. The arithmetic processor 611-q executes second processing included in the parallel processing by using a second unit of processing among the multiple units of processing.

The storage 612-m stores first information to be used by the arithmetic processor 611-m in an aggregate operation in the parallel processing. The storage 612-q stores second information to be used by the arithmetic processor 611-q in the aggregate operation. The first information contains first parent information which indicates that the second unit of processing is a parent of the first unit of processing. The second information contains first child information which indicates that the first unit of processing is a child of the second unit of processing.

For example, in the case of the communication tree information illustrated in FIG. 4, s = 8. In a case where p(7) serves as the first unit of processing and p(6) serves as the second unit of processing among p(0) to p(7), the arithmetic processor 611-7 executes the first processing by using p(7), whereas the arithmetic processor 611-6 executes the second processing by using p(6). The communication tree information of p(7) corresponds to the first information, whereas the communication tree information of p(6) corresponds to the second information.

In the communication tree illustrated in FIG. 3, the node p(6) is the parent node of the node p(7) and the node p(7) is the child node of the node p(6). In this case, “6” in the parent rank number of p(7) corresponds to the first parent information which indicates that the second unit of processing is the parent of the first unit of processing, and “7” in the child rank number 2 of p(6) corresponds to the first child information which indicates that the first unit of processing is the child of the second unit of processing.

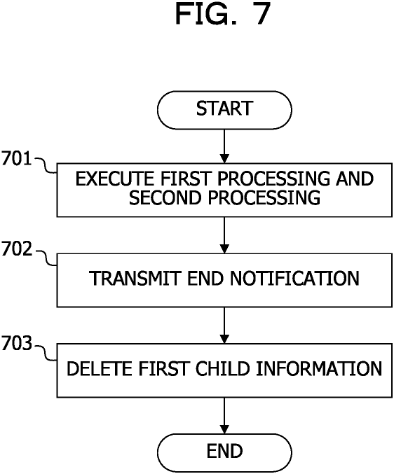

FIG. 7 is a flowchart illustrating an example of the parallel processing performed by the parallel processing apparatus 601 in FIG. 6. The arithmetic processor 611-m executes the first processing by using the first unit of processing, and the arithmetic processor 611-q executes the second processing by using the second unit of processing (step 701).

In a case where the first processing is ended and the first information does not contain information which indicates a child of the first unit of processing, the arithmetic processor 611-m transmits an end notification to the arithmetic processor 611-q (step 702). In a case where the arithmetic processor 611-m receives the end notification from the arithmetic processor 611-m, the arithmetic processor 611-q deletes the first child information from the second information (step 703).

For example, in a case where the first processing using p(7) is ended, the arithmetic processor 611-7 transmits an end notification to the arithmetic processor 611-6 because the communication tree information of p(7) does not contain the child rank number 1 and the child rank number 2. The arithmetic processor 611-6 deletes “7” from the child rank number 2 in the communication tree information of p(6).

In parallel processing including an aggregate operation, the parallel processing apparatus 601 in FIG. 6 is capable of releasing computational resources in the units of processing in the order in which the processing is ended.

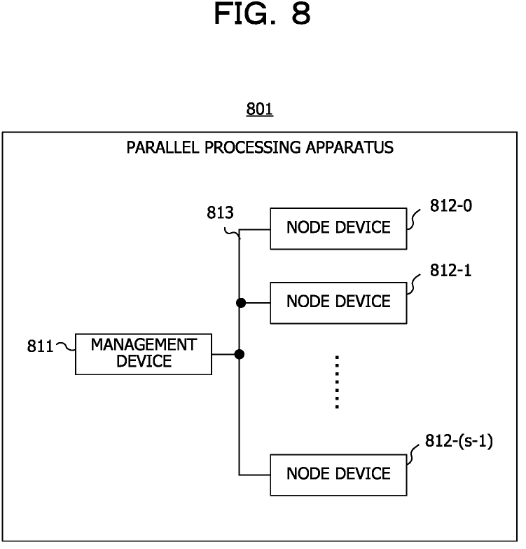

FIG. 8 illustrates a hardware configuration example of a specific example of the parallel processing apparatus 601 in FIG. 6. A parallel processing apparatus 801 in FIG. 8 includes a management device 811 and node devices 812-0 to 812-(s-1). The management device 811 and the node devices 812-r (r = 0 to s-1) are hardware. The management device 811 and the node devices 812-0 to 812-(s-1) are capable of communicating with each other via a communication network 813.

The management device 811 operates as a scheduler, and manages jobs such as parallel processing executed by the node devices 812-0 to 812-(s-1). The node devices 812-0 to 812-(s-1) execute jobs such as parallel processing in accordance with instructions from the management device 811.

The parallel processing includes an aggregate operation. As the parallel processing proceeds, a node device 812-r that does not take charge of data processing or participate in the aggregate operation is generated. Thus, the number of the node devices 812-r participating in the aggregate operation gradually decreases, and the parallelism decreases. The parallel processing may be parallelized causal discovery processing, and the aggregate operation may be Bcast, Reduce, Allreduce, Gather, Allgather, Scatter, or AlltoAll.

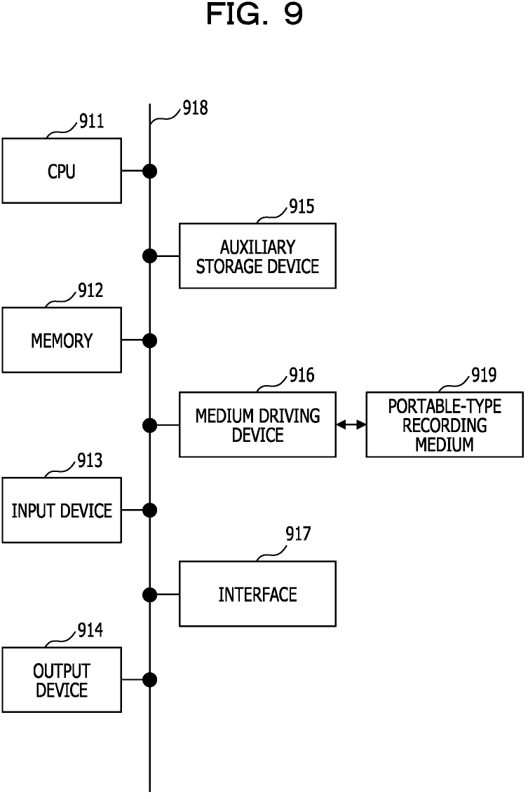

FIG. 9 illustrates a hardware configuration example of an information processor (computer) to be used as the management device 811 in FIG. 8. The management device 811 in FIG. 9 includes a central processing unit (CPU) 911, a memory 912, an input device 913, an output device 914, an auxiliary storage device 915, a medium driving device 916, and an interface 917. These constituent elements are hardware, and are coupled to each other via a bus 918.

For example, the memory 912 is a semiconductor memory such as a read-only memory (ROM) or a random-access memory (RAM) that stores a management program to be used for processing.

For example, the CPU 911 (processor) executes the management program using the memory 912 to operate as a manager. The CPU 911 activates a job by assigning data to each node device 812-r, and manages processing executed by each node device 812-r.

In a case where there are as many free node devices 812-r as the number to be used to execute a job, the CPU 911 instructs these node devices 812-r to execute the job. In a case where the CPU 911 receives a free node notification from the node device 812-r that has ended the data processing among the node devices 812-r being executing the job, the CPU 911 manages the node device 812-r as a free node device. The free node notification is an example of first free information which indicates that the first arithmetic processor is free and second free information which indicates that the second arithmetic processor is free.

The input device 913 is, for example, a keyboard, a pointing device, or the like, and is used to input an instruction or information from a user or operator. The output device 914 is, for example, a display device, a printer or the like, and is used to output an inquiry or instruction and a processing result to the user or operator. In a case where the parallel processing is causal discovery processing, the processing result may be directed causal relationships between variables.

For example, the auxiliary storage device 915 is a magnetic disk device, an optical disk device, a magneto-optical disk device, and a tape device, or the like. The auxiliary storage device 915 may be a hard disk drive or a solid-state drive (SSD).

For example, the management device 811 may store a parallel processing program and data to be used by each node device 812-r in the auxiliary storage device 915. The parallel processing program includes a management program and a node program to be executed by each node device 812-r. In this case, the management device 811 loads the management program from the auxiliary storage device 915 to the memory 912 to use the management program, and transmits the node program and the data to the node devices 812-r. The node program is an example of first to fourth programs.

The medium driving device 916 drives a portable-type recording medium 919, and accesses recorded data. The portable-type recording medium 919 is a memory device, a flexible disk, an optical disk, a magneto-optical disk, or the like. The portable-type recording medium 919 may be a compact disk read-only memory (CD-ROM), a Digital Versatile Disk (DVD), a Universal Serial Bus (USB), or the like.

The user or operator may store the parallel processing program and the data in the portable-type recording medium 919. In this case, the management device 811 loads the management program from the portable-type recording medium 919 to the memory 912 to use the management program, and transmits the node program and the data to the node devices 812-r.

The computer-readable recording medium in which the parallel processing program and the data to be used for processing are stored as described above is a physical (non-transitory) recording medium such as the memory 912, the auxiliary storage device 915, or the portable-type recording medium 919.

The interface 917 is a communication circuit that is coupled to the communication network 813 and performs data conversion for the communication. The management device 811 is capable of receiving the parallel processing program and the data via the interface 917 from an external communication network (not illustrated). In this case, the management device 811 loads the management program contained in the received parallel processing program into the memory 912 to use the management program, and transmits the node program included in the parallel processing program and the received data to the node devices 812-r.

In a job for parallel processing, each node device 812-r generates a process p(r) by executing the node program, and executes processing using the generated process p(r). The processing executed by the node devices 812-r is an example of first processing to fourth processing. The processes p(0) to p(s-1) are an example of multiple units of processing, and the processes p(r) are an example of first to fourth unit of processing.

The management device 811 does not have to include all the constituent elements illustrated in FIG. 9, and some of the constituent elements may be omitted depending on the application or conditions of the management device 811. For example, in a case where an interface to the user or operator is not to be used, the input device 913 and the output device 914 may be omitted. In a case where the portable-type recording medium 919 is not used, the medium driving device 916 may be omitted.

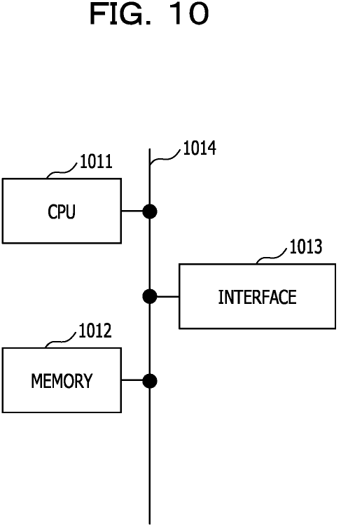

FIG. 10 illustrates a hardware configuration example of an information processor to be used as the node device 812-r illustrated in FIG. 8. The node device 812-r illustrated in FIG. 10 includes a CPU 1011, a memory 1012, and an interface 1013. These constituent elements are hardware, and are coupled to each other via a bus 1014.

The CPU 1011 serves as the arithmetic processor 611-r in FIG. 6, and the memory 1012 serves as the storage 612-r in FIG. 6. The CPU 1011 and the memory 1012 are examples of computational resources of the node device 812-r. The node device 812-r may include two or more CPUs 1011.

For example, the memory 1012 is a semiconductor memory such as a ROM or RAM and stores the node program and the data to be used for processing.

For example, the CPU 1011 executes a job such as parallel processing by executing the node program using the memory 1012. At this time, the CPU 1011 generates a process p(r) by executing the node program, and executes processing by using the generated process p(r).

The interface 1013 is a communication circuit that is coupled to the communication network 813 and performs data conversion for communication. The interface 1013 receives the node program and data from the management device 811, and the node device 812-r stores the received node program and data in the memory 1012.

In a case where the CPU 1011 performs the causal discovery processing, the data stored in the memory 1012 contains observed sample data and communication tree information. The communication tree information contains information on at least one or more of a parent rank number, a child rank number 1, and a child rank number 2, and is used in an aggregate operation by the CPU 1011. The communication tree information is an example of first information to fourth information, the parent rank number is an example of the first parent information to fourth parent information, and the child rank number 1 or the child rank number 2 is an example of the first child information to fourth child information.

As an example, assume a case where the communication tree information in the memory 1012 contains only the parent rank number indicating p(r1) and does not contain the child rank number 1 and the child rank number 2, and the processing being executed by the CPU 1011 is ended.

In this case, in the next aggregate operation, the CPU 1011 transmits an end notification containing the rank number of p(r) to another node device 812-r1 having p(r1) via the interface 1013. The CPU 1011 transmits a free node notification containing the rank number of p(r) and indicating that the CPU 1011 is free to the management device 811 via the interface 1013.

The CPU 1011 of the node device 812-r1 that receives the end notification deletes the child rank number 1 or the child rank number 2 corresponding to the rank number contained in the end notification from the communication tree information. As a result, p(r) does not have to participate in the aggregate operation. Thus, by deleting p(r), it is possible to release the CPU 1011 and the memory 1012 of the node device 812-r.

The CPU 911 of the management device 811 that receives the free node notification manages the node device 812-r having p(r) indicated by the rank number contained in the free node notification as a free node device, and allocates processing of another job to the node device 812-r. Thus, the CPU 1011 and the memory 1012 of the node device 812-r are released and used for the processing of the other job.

As another example, assume a case where the communication tree information in the memory 1012 contains the parent rank number indicating p(r1) and the child rank number 1 or the child rank number 2 indicating p(r2), and the processing being executed by the CPU 1011 is ended.

In this case, in the next aggregate operation, the CPU 1011 transmits a child information update notification containing the rank number of p(r2) to another node device 812-r1 having p(r1) via the interface 1013. The CPU 1011 transmits a parent information update notification containing the rank number of p(r1) to another node device 812-r2 having p(r2) via the interface 1013.

The CPU 1011 transmits a free node notification containing the rank number of p(r) and indicating that the CPU 1011 is free to the management device 811 via the interface 1013.

The CPU 1011 of the node device 812-r1 that receives the child information update notification updates the communication tree information such that the child rank number 1 or the child rank number 2 indicating p(r) is updated to the rank number contained in the child information update notification. Accordingly, the communication tree information is updated to the information from which the rank number of p(r) is deleted and which indicates that p(r2) is the child of p(r1).

The CPU 1011 of the node device 812-r2 that receives the parent information update notification updates the communication tree information such that the parent rank number indicating p(r) is updated to the rank number contained in the parent information update notification. Accordingly, the communication tree information is updated to the information from which the rank number of p(r) is deleted and which indicates that p(r1) is the parent of p(r2).

When the rank number of p(r) is deleted from the communication tree information, p(r) does not have to participate in the aggregate operation. Thus, by deleting p(r), it is possible to release the CPU 1011 and the memory 1012 of the node device 812-r.

The CPU 911 of the management device 811 that receives the free node notification manages the node device 812-r having p(r) indicated by the rank number contained in the free node notification as a free node device, and allocates processing of another job to the node device 812-r. Thus, the CPU 1011 and the memory 1012 of the node device 812-r are released and used for the processing of the other job.

For example, in a case where the node device 812-r ends the processing in descending order of the rank number among the node devices 812-0 to 812-(s-1), the CPU 1011 and the memory 1012 are released in the node device 812-r in descending order of the rank number.

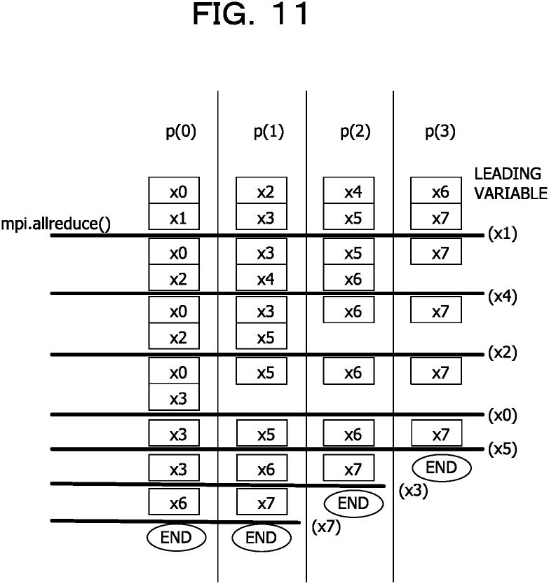

FIG. 11 illustrates an example of an end order in a case where the parallel processing apparatus 801 in FIG. 8 performs the causal discovery processing in FIG. 2. In this case, s = 4, the node device 812-0 executes processing by using p(0), and the node device 812-1 executes processing by using p(1). The node device 812-2 executes processing by using p(2), and the node device 812-3 executes processing by using p(3).

When x5 is determined as the leading variable in the fifth Allreduce and the next processing targets are x3, x6, and x7, no variable is assigned to p(3) and thus the processing by p(3) is ended. Accordingly, p(3) is exempted, and the CPU 1011 and the memory 1012 of the node device 812-3 are released.

Next, when x3 is determined as the leading variable in the sixth Allreduce and the next processing targets are x6 and x7, no variable is assigned to p(2) and thus the processing by p(2) is ended. Accordingly, p(2) is exempted, and the CPU 1011 and the memory 1012 of the node device 812-2 are released.

After that, when x7 is determined as the leading variable in the seventh Allreduce and the order of the variables is confirmed, the processing by p(0) and p(1) is ended. Accordingly, p(0) and p(1) are exempted, and the CPUs 1011 and the memories 1012 of the node devices 812-0 and 812-1 are released.

As described above, in the causal discovery processing in FIG. 11, the node devices 812-r are released in order from the node device 812-r having no assigned variable, which makes it possible to use the computational resources of the node device 812-r for processing of another job.

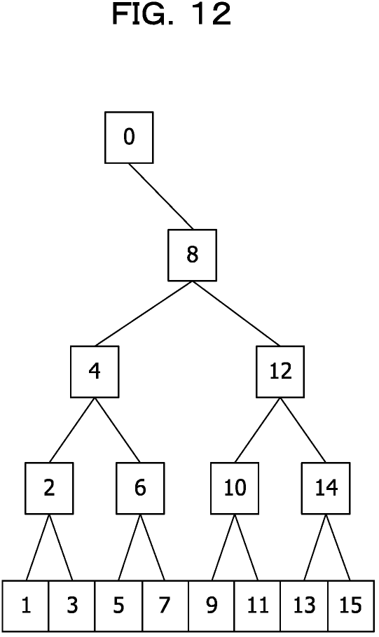

FIG. 12 illustrates an example of a communication tree used in an aggregate operation in parallel processing performed by the parallel processing apparatus 801 in FIG. 8. In this example, s = 16 and the parallel processing is performed by 16 processes p(r) (r = 0 to 15). The process p(r) ends the processing in descending order of the rank number.

The node p(0) has no parent node, and the child node of the node p(0) is the node p(8). The parent node of the node p(8) is the node p(0) and the child nodes of the node p(8) are the nodes p(4) and p(12).

The parent node of the node p(4) is the node p(8), and the child nodes of the node p(4) are the nodes p(2) and p(6). The parent node of the node p(12) is the node p(8), and the child nodes of the node p(12) are the nodes p(10) and p(14).

The parent node of the node p(2) is the node p(4), and the child nodes of the node p(2) are the nodes p(1) and p(3). The parent node of the node p(6) is the node p(4), and the child nodes of the node p(6) are the nodes p(5) and p(7).

The parent node of the node p(10) is the node p(12), and the child nodes of the node p(10) are the nodes p(9) and p(11). The parent node of the node p(14) is the node p(12), and the child nodes of the node p(14) are the nodes p(13) and p(15).

The parent node of the nodes p(1) and p(3) is the node p(2), and the parent node of the nodes p(5) and p(7) is the node p(6). The parent node of the nodes p(9) and p(11) is the node p(10), and the parent node of the nodes p(13) and p(15) is the node p(14). The nodes p(1), p(3), p(5), p(7), p(9), p(11), p(13), and p(15) have no child nodes.

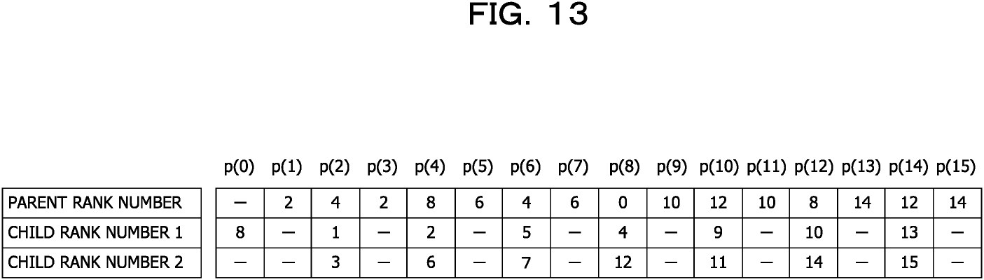

FIG. 13 illustrates an example of communication tree information stored in the node devices 812-r having the respective processes p(r) in FIG. 12. As in the communication tree information in FIG. 4, the communication tree information in FIG. 13 contains a parent rank number, a child rank number 1, and a child rank number 2.

The child rank number 1 of p(r) is smaller than r, and the child rank number 2 of p(r) is larger than r. Accordingly, in a case where p(r) ends the processing in descending order of r, the process indicated by the child rank number 2 transmits the end notification and the child information update notification to p(r). At the time when p(r) ends the processing, the process indicated by the child rank number 2 of p(r) has already ended the processing, and the rank number of the process has been deleted from the child rank number 2.

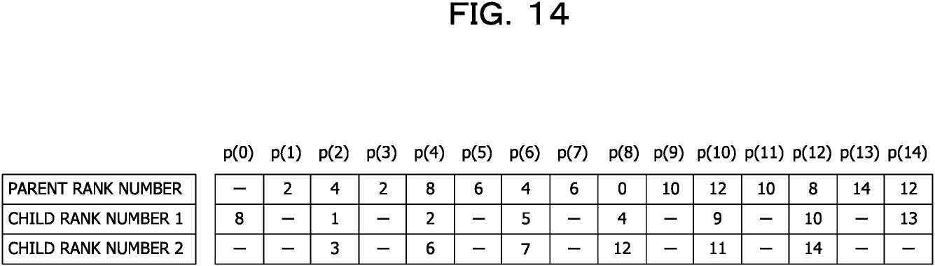

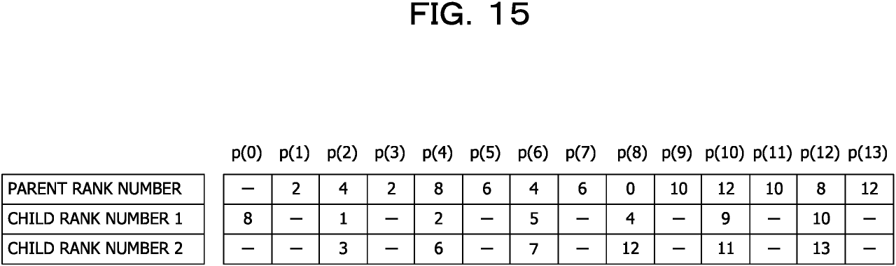

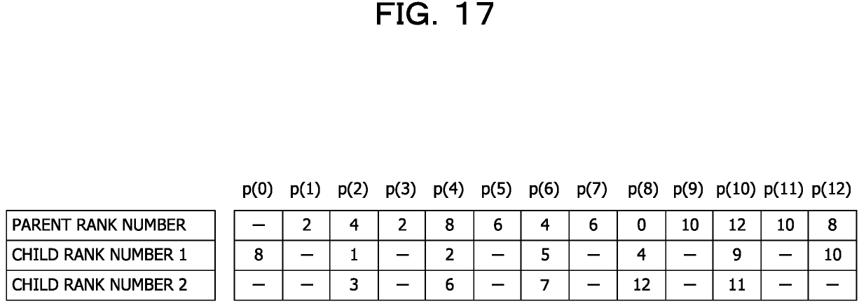

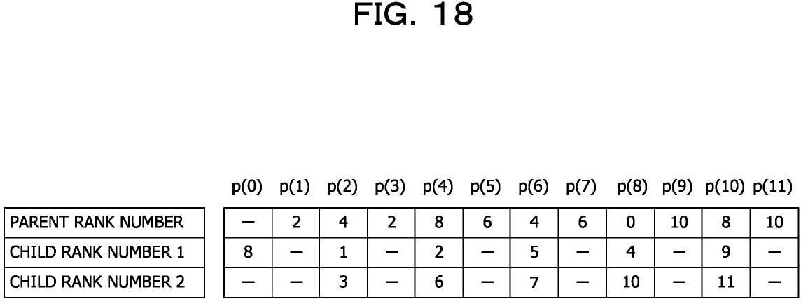

FIG. 14 illustrates an example of the communication tree information after a first change, and FIG. 15 illustrates an example of the communication tree information after a second change. FIG. 17 illustrates an example of the communication tree information after a third change, and FIG. 18 illustrates an example of the communication tree information after a fourth change.

Among p(0) to p(15), p(15) ends the processing first. Because the communication tree information of p(15) does not contain the child rank number 1 and the child rank number 2, the node device 812-15 having p(15) transmits an end notification containing the rank number “15” of p(15) to p(14) indicated by the parent rank number “14”.

The node device 812-14 having p(14) deletes the rank number “15” contained in the received end notification from the child rank number 2 in the communication tree information of p(14). Accordingly, the communication tree information of p(14) is changed as illustrated in FIG. 14.

Next, p(14) ends the processing. Because the communication tree information of p(14) contains the child rank number 1, the node device 812-14 having p(14) transmits the child information update notification containing “13” in the child rank number 1 to p(12) indicated by the parent rank number “12”. The node device 812-14 transmits a parent information update notification containing the parent rank number “12” to p(13) indicated by “13” in the child rank number 1.

The node device 812-12 having p(12) updates the communication tree information of p(12) such that “14” in the child rank number 2 indicating p(14) is updated to the rank number “13” contained in the received child information update notification. Accordingly, the communication tree information of p(12) is changed as illustrated in FIG. 15.

The node device 812-13 having p(13) updates the communication tree information of p(13) such that the parent rank number “14” indicating p(14) is updated to the rank number “12” contained in the received parent information update notification. Accordingly, the communication tree information of p(13) is changed as illustrated in FIG. 15.

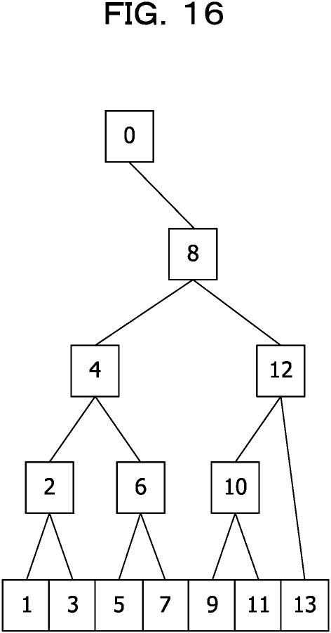

FIG. 16 illustrates an example of the communication tree after the first change indicated by the communication tree information in FIG. 15. In the communication tree in FIG. 16, the nodes p(15) and p(14) are deleted, and the parent node of the node p(13) is changed to the node p(12).

Next, p(13) ends the processing. Because the communication tree information of p(13) does not contain the child rank number 1 and the child rank number 2, the node device 812-13 having p(13) transmits an end notification containing the rank number “13” of p(13) to p(12) indicated by the parent rank number “12”.

The node device 812-12 having p(12) deletes the rank number “13” contained in the received end notification from the child rank number 2 in the communication tree information of p(12). Accordingly, the communication tree information of p(12) is changed as illustrated in FIG. 17.

Next, p(12) ends the processing. Because the communication tree information of p(12) contains the child rank number 1, the node device 812-12 having p(12) transmits a child information update notification containing “10” in the child rank number 1 to p(8) indicated by the parent rank number “8”. The node device 812-12 transmits a parent information update notification containing the parent rank number “8” to p(10) indicated by “10” in the child rank number 1.

The node device 812-8 having p(8) updates the communication tree information of p(8) such that “12” in the child rank number 2 indicating p(12) is updated to the rank number “10” contained in the received child information update notification. Accordingly, the communication tree information of p(8) is changed as illustrated in FIG. 18.

The node device 812-10 having p(10) updates the communication tree information of p(10) such that the parent rank number “12” indicating p(12) is updated to the rank number “8” contained in the received parent information update notification. Accordingly, the communication tree information of p(10) is changed as illustrated in FIG. 18.

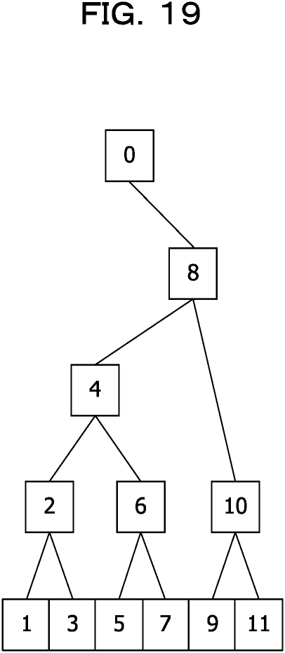

FIG. 19 illustrates an example of the communication tree after the second change indicated by the communication tree information in FIG. 18. In the communication tree illustrated in FIG. 19, the nodes p(13) and p(12) are deleted, and the parent node of the node p(10) is changed to the node p(8).

In the same way, p(11) to p(0) end the processing one after another. Every time any p(r) ends the processing, the node p(r) is deleted from the communication tree. This makes it possible to release the computational resources occupied by p(r) in the order in which the processing is ended.

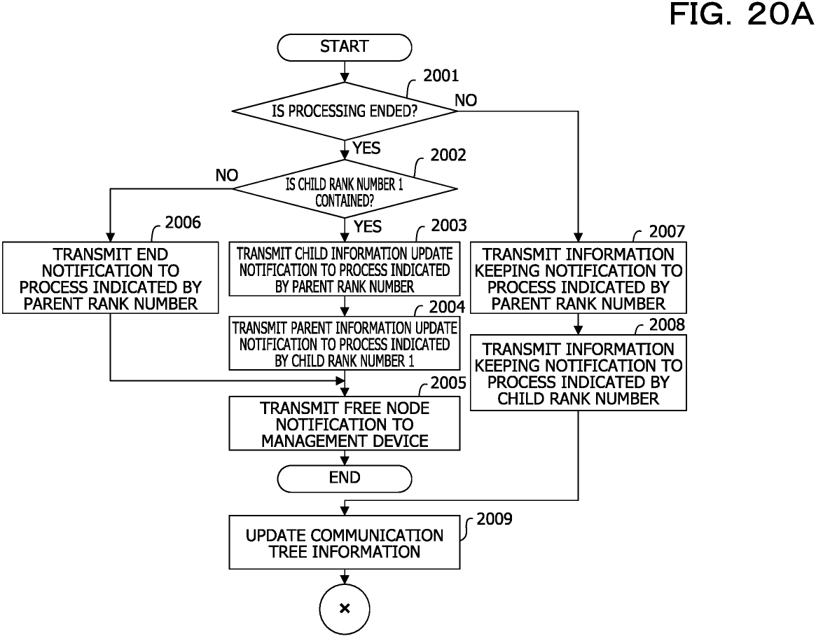

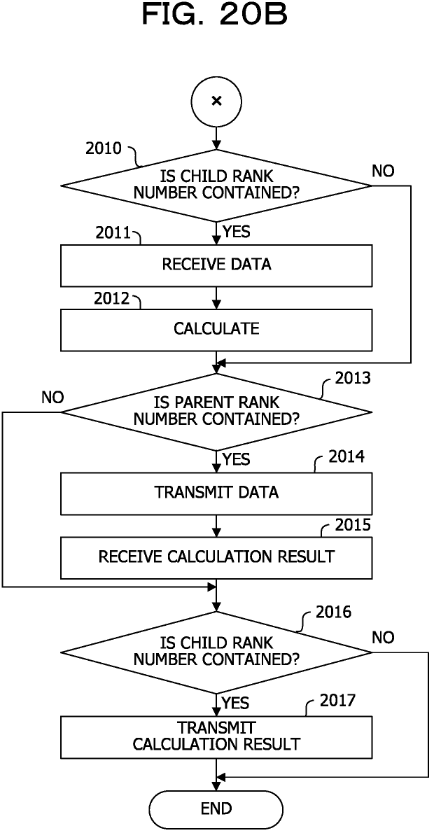

FIGS. 20A and 20B present a flowchart illustrating an example of an aggregate operation performed by each node device 812-r in FIG. 8. First, the CPU 1011 of the node device 812-r checks whether or not processing being executed using p(r) is ended (step 2001).

In a case where the processing being executed is ended (YES in step 2001), the CPU 1011 checks whether or not the communication tree information in the memory 1012 contains the child rank number 1 (step 2002).

In a case where the communication tree information contains the child rank number 1 (YES in step 2002), the CPU 1011 transmits a child information update notification containing the child rank number 1 to the process indicated by the parent rank number via the interface 1013 (step 2003). The CPU 1011 transmits a parent information update notification containing the parent rank number to the process indicated by the child rank number 1 via the interface 1013 (step 2004).

Next, the CPU 1011 transmits a free node notification containing the rank number of p(r) and indicating that the CPU 1011 is free to the management device 811 via the interface 1013 (step 2005), and ends the processing.

On the other hand, in a case where the communication tree information does not contain the child rank number 1 (NO in step 2002), the CPU 1011 transmits an end notification containing the rank number of p(r) to the process indicated by the parent rank number via the interface 1013 (step 2006).

Next, the CPU 1011 transmits a free node notification containing the rank number of p(r) and indicating that the CPU 1011 is free to the management device 811 via the interface 1013 (step 2005), and ends the processing.

It step 2005, the CPU 911 of the management device 811 refers to the rank number contained in the received free node notification, and manages the node device 812-r having p(r) indicated by the rank number as a free node device.

In a case where the processing being executed is not ended (NO in step 2001), the CPU 1011 transmits an information keeping notification containing the rank number of p(r) to the process indicated by the parent rank number via the interface 1013 (step 2007). In a case where the communication tree information does not contain the parent rank number, the processing in step 2007 is skipped.

Next, the CPU 1011 transmits an information keeping notification containing the rank number of p(r) to the process indicated by the child rank number via the interface 1013 (step 2008).

For example, in a case where the communication tree information contains the child rank number 1 and the child rank number 2, the CPU 1011 transmits the information keeping notification to the process indicated by the child rank number 1 and the process indicated by the child rank number 2. For example, in a case where the communication tree information contains only the child rank number 1, the CPU 1011 transmits the information keeping notification to the process indicated by the child rank number 1. In a case where the communication tree information does not contain the child rank number, the processing in step 2008 is skipped.

By transmitting the information keeping notification to the process indicated by the parent rank number and the process indicated by the child rank number, it is possible to notify the other node devices 812-r having these processes that the processing being executed is not ended. Accordingly, in the communication tree information stored in the other node devices 812-r, the rank number of p(r) is not deleted but is kept.

Next, the CPU 1011 updates the communication tree information in accordance with the received notification (step 2009). In a case where the child information update notification is received, the CPU 1011 updates the child rank number 2 contained in the communication tree information to the rank number contained in the child information update notification. In a case where the parent information update notification is received, the CPU 1011 updates the parent rank number contained in the communication tree information to the rank number contained in the parent information update notification.

In a case where the end notification is received, the CPU 1011 deletes the rank number contained in the end notification from the child rank number 2 contained in the communication tree information. In a case where the information keeping notification is received, the CPU 1011 does not update the communication tree information.

Next, the CPU 1011 checks whether or not the communication tree information contains the child rank number (step 2010). In a case where the communication tree information does not contain the child rank number (NO in step 2010), the CPU 1011 performs the processing in step 2013 and subsequent steps.

In a case where the communication tree information contains the child rank number (YES in step 2010), the CPU 1011 receives data from the process indicated by the child rank number via the interface 1013 (step 2011).

In a case where the communication tree information contains the child rank number 1 and the child rank number 2, the CPU 1011 receives data from the process indicated by the child rank number 1 and the process indicated by the child rank number 2. In a case where the communication tree information contains only the child rank number 1, the CPU 1011 receives data from the process indicated by the child rank number 1.

In a case where the node of the process indicated by the child rank number 1 or the child rank number 2 has a child node, the CPU 1011 receives, as data, a calculation result of an aggregate operation from the process indicated by the child rank number 1 or the child rank number 2.

Subsequently, the CPU 1011 uses the received data and the data held by the node device 812-r to perform a calculation for an aggregate operation (step 2012).

Next, the CPU 1011 checks whether or not the communication tree information contains the parent rank number (step 2013). In a case where the communication tree information does not contain the parent rank number (NO in step 2013), the CPU 1011 performs processing in step 2016 and subsequent steps.

In a case where the communication tree information contains the parent rank number (YES in step 2013), the CPU 1011 transmits data to the process indicated by the parent rank number via the interface 1013 (step 2014).

In a case where the communication tree information contains the child rank number (YES in step 2010), the CPU 1011 transmits, as the data, the calculation result of the aggregate operation generated in step 2012. In a case where the communication tree information does not contain the child rank number (NO in step 2010), the CPU 1011 transmits the data held by the node device 812-r.

Next, the CPU 1011 receives the calculation result of the aggregate operation from the process indicated by the parent rank number via the interface 1013 (step 2015).

Next, the CPU 1011 checks whether or not the communication tree information contains the child rank number (step 2016). In a case where the communication tree information does not contain the child rank number (NO in step 2016), the CPU 1011 ends the processing.

In a case where the communication tree information contains the child rank number (YES in step 2016), the CPU 1011 transmits the calculation result of the aggregate operation to the process indicated by the child rank number via the interface 1013 (step 2017).

In a case where the communication tree information contains the child rank number 1 and the child rank number 2, the CPU 1011 transmits the calculation result of the aggregate operation to the process indicated by the child rank number 1 and the process indicated by the child rank number 2. In a case where the communication tree information contains only the child rank number 1, the CPU 1011 transmits the calculation result of the aggregate operation to the process indicated by the child rank number 1.

In a case where the communication tree information contains the parent rank number (YES in step 2013), the CPU 1011 transmits the calculation result of the aggregate operation received in step 2015. In a case where the communication tree information does not contain the parent rank number (NO in step 2013), the CPU 1011 transmits the calculation result of the aggregate operation generated in step 2012.

According to the parallel processing apparatus 801 in FIG. 8, an aggregate operation in a case where the number of node devices 812-r that execute parallel processing gradually decreases may be executed only by the remaining node devices 812-r excluding the node device 812-r which has ended the processing. The processing for excluding the node device 812-r which has ended the processing is accomplished only by minimum communication between the node device 812-r serving as the parent node and the node device 812-r serving as the child node based on the communication tree information containing a small amount of information.

In contrast, in a case where the communication tree for an aggregate operation is reconstructed every time any node device 812-r ends the processing, communication with all the other node devices 812-r occurs, so that the amount of communication and the processing time increase.

Because a node device 812-r excluded from an aggregate operation does not have to perform communication in the subsequent processing, the node device 812-r is enabled to delete the process without waiting for completion of the entire parallel processing. Since the node device 812-r transmits the free node notification to the management device 811 when ending the processing, the management device 811 may recognize the node device 812-r as a free node device and allocate a next job to the node device 812-r.

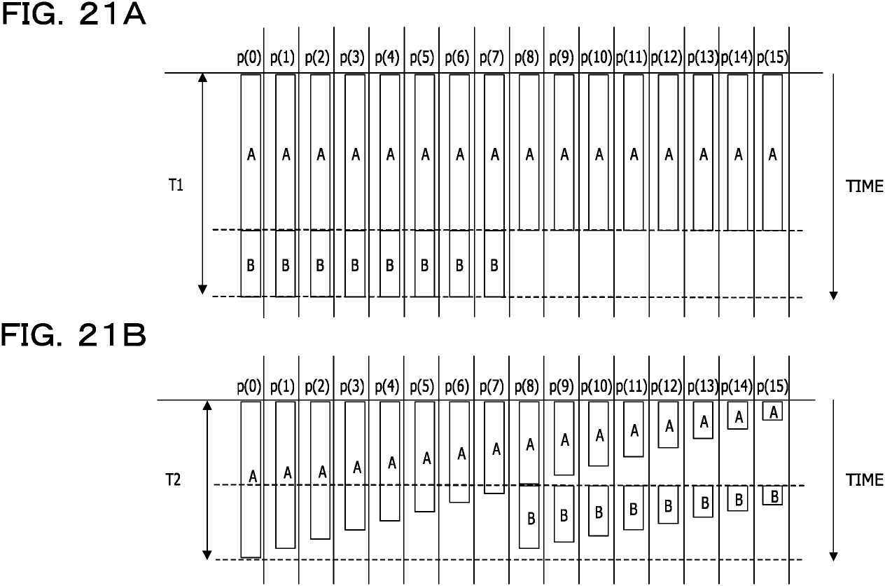

FIGS. 21A and 21B illustrate examples of processing times in a case where two types of causal discovery processing jobs are executed. FIG. 21A illustrates an example of a processing time in a case where a parallel processing apparatus in a comparative example executes a job A and a job B.

The job A represents causal discovery processing to be executed for 16 variables by 16 processes p(r) and the job B represents causal discovery to be executed for 8 variables by 8 processes p(r).

In the parallel processing apparatus in the comparative example, any p(r) is not exempted until the entire job A is completed and therefore the job B is started after the entire job A is completed. In this case, the processing time of the jobs A and B is T1.

FIG. 21B illustrates an example of a processing time in a case where the parallel processing apparatus 801 illustrated in FIG. 8 executes the jobs A and B. In the parallel processing apparatus 801, even while the entire job A is not completed, p(r) is exempted in order from p(15) at the time when the processing is ended and therefore it is possible to start the job B early by using the free computational resources.

For example, at the time when p(8) ends the processing, 8 node devices 812-r are free node devices and the job B is started. In this case, the processing time of the jobs A and B is T2, which is shorter than the processing time T1 in FIG. 21A.

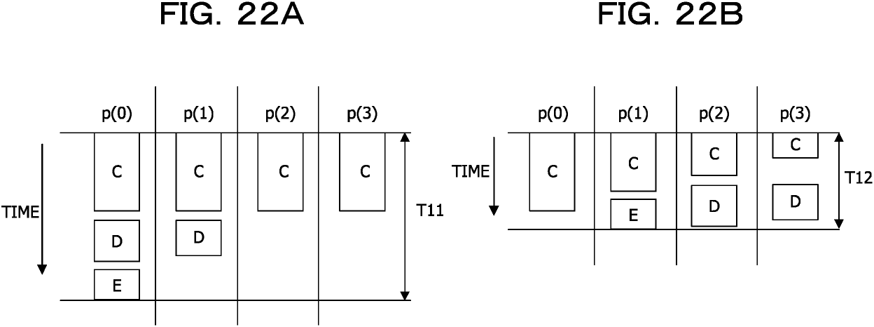

FIGS. 22A and 22B illustrate examples of processing times in a case where three types of jobs are executed. FIG. 22A illustrates an example of a processing time in a case where a parallel processing apparatus in a comparative example executes a job C, a job D, and a job E.

The job C represents parallel processing by four processes p(r), the job D represents parallel processing by two processes p(r), and the job E represents processing by one process p(r).

In the parallel processing apparatus in the comparative example, the job D is started after the entire job C is completed, and the job E is started after the entire job D is completed. In this case, the processing time of the jobs C, D, and E is T11.

FIG. 22B illustrates an example of a processing time in a case where the parallel processing apparatus 801 illustrated in FIG. 8 executes the jobs C, D, and E. In the parallel processing apparatus 801, at a time point when p(2) ends the processing in the job C, two node devices 812-r are free node devices and the job D is started. At a time point when p(1) ends the processing in the job C, the job E is started. In this case, the processing time of the jobs C, D, and E is T12, which is shorter than the processing time T11 illustrated in FIG. 22A.

The configurations of the parallel processing apparatus 601 in FIG. 6 and the parallel processing apparatus 801 in FIG. 8 are merely examples, and some of the constituent elements may be omitted or modified in accordance with an application or conditions of the parallel processing apparatus.

The configurations of the management device 811 in FIG. 9 and the node device 812-r in FIG. 10 are merely examples, and some of the constituent elements may be omitted or modified in accordance with an application or conditions of the parallel processing apparatus 801. For example, in the node device 812-r in FIG. 10, another arithmetic processing device such as a graphics processing unit (GPU) may be used instead of the CPU 1011, and another unit of processing such as a thread may be used instead of a process.

The flowcharts in FIGS. 7, 20A, and 20B are merely examples, and some portions of the processing may be omitted or modified in accordance with a configuration or conditions of the parallel processing apparatus.

The sample data and causal relationships illustrated in FIGS. 1A and 1B are merely examples. The sample data varies depending on an observation target, and the causal relationships vary depending on the sample data. The causal discovery processing illustrated in FIGS. 2 and 11 is merely an example, and the causal discovery processing varies depending on the number of variables and the number of processes.

The communication trees illustrated in FIGS. 3, 12, 16, and 19 are merely examples, and the communication tree varies depending on the number of processes. The communication tree information illustrated in FIGS. 4, 13, 14, 15, 17, and 18 is merely examples, and the communication tree information varies depending on the communication tree.

Allreduce illustrated in FIG. 5 is merely an example, and Allreduce varies depending on the communication tree information and a type of calculation. The processing times illustrated in FIGS. 21A to 22B are merely examples, and the processing time of jobs varies depending on the jobs.

The formulae (1) to (3) are merely examples, and a calculation formula representing a causal relationship varies depending on sample data.

Although the disclosed embodiment and its advantages have been described in detail, those skilled in the art could make various modifications, additions, and omissions without deviating from the scope of the present disclosure clearly recited in claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A parallel processing apparatus comprising a plurality of arithmetic processors and a plurality of storages, wherein
a first arithmetic processor among the plurality of arithmetic processors executes processing for executing first processing included in parallel processing by using a first unit of processing among a plurality of units of processing,
a second arithmetic processor among the plurality of arithmetic processors executes processing for executing second processing included in the parallel processing by using a second unit of processing among the plurality of units of processing,
a first storage among the plurality of storages stores first information to be used by the first arithmetic processor in an aggregate operation in the parallel processing,
a second storage among the plurality of storages stores second information to be used by the second arithmetic processor in the aggregate operation,
the first information contains first parent information which indicates that the second unit of processing is a parent of the first unit of processing,
the second information contains first child information which indicates that the first unit of processing is a child of the second unit of processing,
the first arithmetic processor further executes processing for transmitting an end notification to the second arithmetic processor in a case where the first processing is ended and the first information does not contain information which indicates a child of the first unit of processing, and
the second arithmetic processor further executes processing for deleting the first child information from the second information in a case where the second arithmetic processor receives the end notification from the first arithmetic processor.

2. The parallel processing apparatus according to claim 1, wherein
the parallel processing apparatus further comprises a manager processor that manages the plurality of arithmetic processors,
the first arithmetic processor further executes processing for transmitting, to the manager processor, first free information which indicates that the first arithmetic processor is free in the case where the first processing is ended and the first information does not contain information which indicates the child of the first unit of processing, and
the manager processor executes processing for allocating processing other than the parallel processing to the first arithmetic processor in a case where the manager receives the first free information from the first arithmetic processor.

3. The parallel processing apparatus according to claim 2, wherein
a third arithmetic processor among the plurality of arithmetic processors executes processing for executing third processing included in the parallel processing by using a third unit of processing among the plurality of units of processing,
a fourth arithmetic processor among the plurality of arithmetic processors executes processing for executing fourth processing included in the parallel processing by using a fourth unit of processing among the plurality of units of processing,
a third storage among the plurality of storages stores third information to be used by the third arithmetic processor in the aggregate operation,
a fourth storage among the plurality of storages stores fourth information to be used by the fourth arithmetic processor in the aggregate operation,
the second information further contains second parent information which indicates that the fourth unit of processing is a parent of the second unit of processing and second child information which indicates that the third unit of processing is a child of the second unit of processing,
the third information contains third parent information which indicates that the second unit of processing is a parent of the third unit of processing,
the fourth information contains third child information which indicates that the second unit of processing is a child of the fourth unit of processing,
in a case where the second processing is ended after the first processing is ended, the second arithmetic processor executes processing for transmitting a parent information update notification containing identification information of the fourth unit of processing to the third arithmetic processor, transmitting a child information update notification containing identification information of the third unit of processing to the fourth arithmetic processor, and transmitting second free information which indicates that the second arithmetic processor is free to the manager processor,
in a case where the third arithmetic processor receives the parent information update notification from the second arithmetic processor, the third arithmetic processor executes processing for updating the third parent information contained in the third information to fourth parent information which indicates that the fourth unit of processing is a parent of the third unit of processing,
in a case where the fourth arithmetic processor receives the child information update notification from the second arithmetic processor, the fourth arithmetic processor executes processing for updating the third child information contained in the fourth information to fourth child information which indicates that the third unit of processing is a child of the fourth unit of processing, and
in a case where the manager receives the second free information from the second arithmetic processor, the manager processor executes processing for allocating processing other than the parallel processing to the second arithmetic processor.

4. The parallel processing apparatus according to claim 3, wherein
the second arithmetic processor executes processing for transmitting an information keeping notification to the third arithmetic processor and the fourth arithmetic processor in a case where the second processing is not ended.

5. A non-transitory computer-readable recording medium storing a parallel processing program for a parallel processing apparatus that includes a plurality of arithmetic processors and a plurality of storages, wherein
the parallel processing program comprises a first program and a second program,
the first program causes a first arithmetic processor among the plurality of arithmetic processors to execute processing for executing first processing included in parallel processing by using a first unit of processing among a plurality of units of processing,
the second program causes a second arithmetic processor among the plurality of arithmetic processors to execute processing for executing second processing included in the parallel processing by using a second unit of processing among the plurality of units of processing,
a first storage among the plurality of storages stores first information to be used by the first arithmetic processor in an aggregate operation in the parallel processing,
a second storage among the plurality of storages stores second information to be used by the second arithmetic processor in the aggregate operation,
the first information contains first parent information which indicates that the second unit of processing is a parent of the first unit of processing,
the second information contains first child information which indicates that the first unit of processing is a child of the second unit of processing,
the first program causes the first arithmetic processor to execute processing for transmitting an end notification to the second arithmetic processor in a case where the first processing is ended and the first information does not contain information which indicates a child of the first unit of processing, and
the second program causes the second arithmetic processor to execute processing for deleting the first child information from the second information in a case where the second arithmetic processor receives the end notification from the first arithmetic processor.

6. The non-transitory computer-readable recording medium according to claim 5, wherein
the parallel processing apparatus further includes a manager that manages the plurality of arithmetic processors,
the parallel processing program further comprises a management program,
the first program causes the first arithmetic processor to execute processing for transmitting, to the manager, first free information which indicates that the first arithmetic processor is free in the case where the first processing is ended and the first information does not contain information which indicates the child of the first unit of processing, and
the management program causes the manager to execute processing for allocating processing other than the parallel processing to the first arithmetic processor in a case where the manager receives the first free information from the first arithmetic processor.

7. The non-transitory computer-readable recording medium according to claim 6, wherein
the parallel processing program further comprises a third program and a fourth program,
the third program causes a third arithmetic processor among the plurality of arithmetic processors to execute processing for executing third processing included in the parallel processing by using a third unit of processing among the plurality of units of processing,
the fourth program causes a fourth arithmetic processor among the plurality of arithmetic processors to execute processing for executing fourth processing included in the parallel processing by using a fourth unit of processing among the plurality of units of processing,
a third storage among the plurality of storages stores third information to be used by the third arithmetic processor in the aggregate operation,
a fourth storage among the plurality of storages stores fourth information to be used by the fourth arithmetic processor in the aggregate operation,
the second information further contains second parent information which indicates that the fourth unit of processing is a parent of the second unit of processing and second child information which indicates that the third unit of processing is a child of the second unit of processing,
the third information contains third parent information which indicates that the second unit of processing is a parent of the third unit of processing,
the fourth information contains third child information which indicates that the second unit of processing is a child of the fourth unit of processing,
in a case where the second processing is ended after the first processing is ended, the second program causes the second arithmetic processor to execute processing for transmitting a parent information update notification containing identification information of the fourth unit of processing to the third arithmetic processor, transmitting a child information update notification containing identification information of the third unit of processing to the fourth arithmetic processor, and transmitting second free information which indicates that the second arithmetic processor is free to the manager,
in a case where the third arithmetic processor receives the parent information update notification from the second arithmetic processor, the third program causes the third arithmetic processor to execute processing for updating the third parent information contained in the third information to fourth parent information which indicates that the fourth unit of processing is a parent of the third unit of processing,
in a case where the fourth arithmetic processor receives the child information update notification from the second arithmetic processor, the fourth program causes the fourth arithmetic processor to execute processing for updating the third child information contained in the fourth information to fourth child information which indicates that the third unit of processing is a child of the fourth unit of processing, and
in a case where the manager receives the second free information from the second arithmetic processor, the management program causes the manager to execute processing for allocating processing other than the parallel processing to the second arithmetic processor.

8. The non-transitory computer-readable recording medium according to claim 7, wherein
the second program causes the second arithmetic processor to execute processing for transmitting an information keeping notification to the third arithmetic processor and the fourth arithmetic processor in a case where the second processing is not ended.
